(19) United States
(12) Patent Application Publication
(10) Pub. No.: US 2015/0103909 A1
(43) Pub. Date: Apr. 16, 2015

(54) MULTI-THREADED VIDEO ENCODER

(71) Applicant: QUALCOMM Incorporated, San Diego, CA (US)

(72) Inventors: Umesh Kumar Pandey, San Diego, CA (US); Xinping Zhang, San Diego, CA (US); Aditya Bhuvanagiri, Hyderabad (IN); Kim-Chyan Gan, Sammamish, WA (US); Santhosh Kumar Gunna, Hyderabad (IN); Adithya Prakash, San Diego, CA (US); Aravind Korlepara, Hyderabad (IN); Jayant Ingale, Hyderabad (IN); Arjun Sitaram, Secunderabad (IN); Revathy Shunmugam, Hyderabad (IN)

(21) Appl. No.: 14/322,350

(22) Filed: Jul. 2, 2014

Related U.S. Application Data
(60) Provisional application No. 61/890,588, filed on Oct. 14, 2013.

(51) Int. Cl. H04N 19/503; H04N 19/119; H04N 19/593

(52) U.S. Cl. CPC H04N 19/00575; H04N 19/00763; H04N 19/00072
USPC 375/240.13

(57) ABSTRACT

The techniques of this disclosure relate to video encoding and include using an inter mode determination for neighboring blocks, rather than the final prediction mode determination for the neighboring block, when determining an inter mode for a current block. In this way, inter mode and intra mode estimation may be separated and performed in different stages of a multi-threaded parallel video encoding implementation. In addition, this disclosure also proposes generating sub-pixel values in a third stage of the multi-threaded parallel video encoding implementation at a frame level, rather than for each macroblock during inter mode estimation process for that macroblock.

This application claims the benefit of U.S. Provisional Application No. 61/890,588, filed Oct. 14, 2013.

### TECHNICAL FIELD

This disclosure relates to video encoding.

### BACKGROUND

Digital video capabilities can be incorporated into a wide range of devices, including digital televisions, digital direct broadcast systems, wireless broadcast systems, personal digital assistants (PDAs), laptop or desktop computers, digital cameras, digital recording devices, video gaming devices, video game consoles, cellular or satellite radio telephones, and the like. Digital video devices implement video compression techniques, such as those described in standards defined by MPEG-2, MPEG-4, or ITU-T H.264/MPEG-4, Part 10, Advanced Video Coding (AVC), or other standards, to transmit and receive digital video information more efficiently. Video compression techniques may perform spatial prediction and/or temporal prediction to reduce or remove redundancy inherent in video sequences.

Intra-coding relies on spatial prediction to reduce or remove spatial redundancy between video blocks within a given coded unit. Inter-coding relies on temporal prediction to reduce or remove temporal redundancy between video blocks in successive coded units of a video sequence. For inter-coding, a video encoder performs motion estimation and compensation to identify, in reference units, prediction blocks that closely match blocks in a unit to be encoded, and generate motion vectors indicating relative displacement between the encoded blocks and the prediction blocks. The difference between the encoded blocks and the prediction blocks constitutes residual information. Hence, an inter-coded block can be characterized by one or more motion vectors and residual information.

### SUMMARY

This disclosure describes techniques for video encoding, and in particular, techniques for a parallel video encoding implementation on a multi-threaded processor. The techniques of this disclosure include selecting the best inter mode determination for neighboring blocks, rather than the final prediction mode determination for the neighboring blocks, as an inter mode for a current block. In this way, inter mode and intra mode estimation may be separated and performed in different stages of a multi-threaded parallel video encoding implementation. In addition, this disclosure also proposes generating sub-pixel values in a third stage of the multi-threaded parallel video encoding implementation at a frame level, rather than for each macroblock during the inter mode estimation process for that macroblock.

In one example of the disclosure, a method of encoding video data comprises determining an inter-prediction mode for a current macroblock of a frame of video data based on a neighbor motion vector predictor and a neighbor inter-prediction mode from one or more neighboring blocks, wherein the inter-prediction mode for the current macroblock is determined without considering a neighbor final prediction mode determined for the one or more neighboring blocks, determining an intra prediction mode for the current macroblock, determining a final prediction mode for the current macroblock from one of the determined inter prediction mode and the determined intra prediction mode, and performing a prediction process on the current macroblock using the final prediction mode.

In another example of the disclosure, an apparatus configured to encode video data comprises a video memory configured to store video data, and a video encoder operatively coupled to the video memory, the video encoder configured to determine an inter-prediction mode for a current macroblock of a frame of video data based on a neighbor motion vector predictor and a neighbor inter-prediction mode from one or more neighboring blocks, wherein the inter-prediction mode for the current macroblock is determined without considering a neighbor final prediction mode determined for the one or more neighboring blocks, determine an intra prediction mode for the current macroblock, determine a final prediction mode for the current macroblock from one of the determined inter prediction mode and the determined intra prediction mode, and perform a prediction process on the current macroblock using the final prediction mode.

In another example of the disclosure, an apparatus configured to encode video data comprises means for determining an inter-prediction mode for a current macroblock of a frame of video data based on a neighbor motion vector predictor and a neighbor inter-prediction mode from one or more neighboring blocks, wherein the inter-prediction mode for the current macroblock is determined without considering a neighbor final prediction mode determined for the one or more neighboring blocks, means for determining an intra prediction mode for the current macroblock, means for determining a final prediction mode for the current macroblock from one of the determined inter prediction mode and the determined intra prediction mode, and means for performing a prediction process on the current macroblock using the final prediction mode.

In another example, this disclosure describes a computer-readable storage medium storing instructions that, when executed, cause one or more processors of a device configured to encode video data to determine an inter-prediction mode for a current macroblock of a frame of video data based on a neighbor motion vector predictor and a neighbor inter-prediction mode from one or more neighboring blocks, wherein the inter-prediction mode for the current macroblock is determined without considering a neighbor final prediction mode determined for the one or more neighboring blocks, determine an intra prediction mode for the current macroblock, determine a final prediction mode for the current macroblock from one of the determined inter prediction mode and the determined intra prediction mode, and perform a prediction process on the current macroblock using the final prediction mode.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram illustrating an example video encoding and decoding system configured to implement the techniques of this disclosure.

FIG. 2 is a block diagram illustrating an example of a video encoder configured to implement the techniques of this disclosure.

FIG. 3 is a conceptual diagram showing one example of a motion estimation and mode decision algorithm used in an H.264 implementation.

FIG. 4 is a conceptual diagram showing motion vector predictors and the final modes of neighboring macroblocks used to decide the final mode of a current macroblock.

FIG. 5 is a conceptual diagram showing a multi-threaded implementation of a video encoder according to the techniques of this disclosure.

FIG. 6 is a conceptual diagram showing an example method for staggering of deblocking and sub-pixel filtering in a video encoding process.

FIG. 7 is a flowchart showing an example method of this disclosure.

### DETAILED DESCRIPTION

Prior proposals for implementing parallel video encoding in a multi-threaded processing system exhibit various drawbacks. Such drawbacks include poor thread balancing, as well as poor usage of data and instruction caches. In view of these drawbacks, this disclosure proposes devices and techniques for implementing parallel video encoding in a multi-threaded processing system.

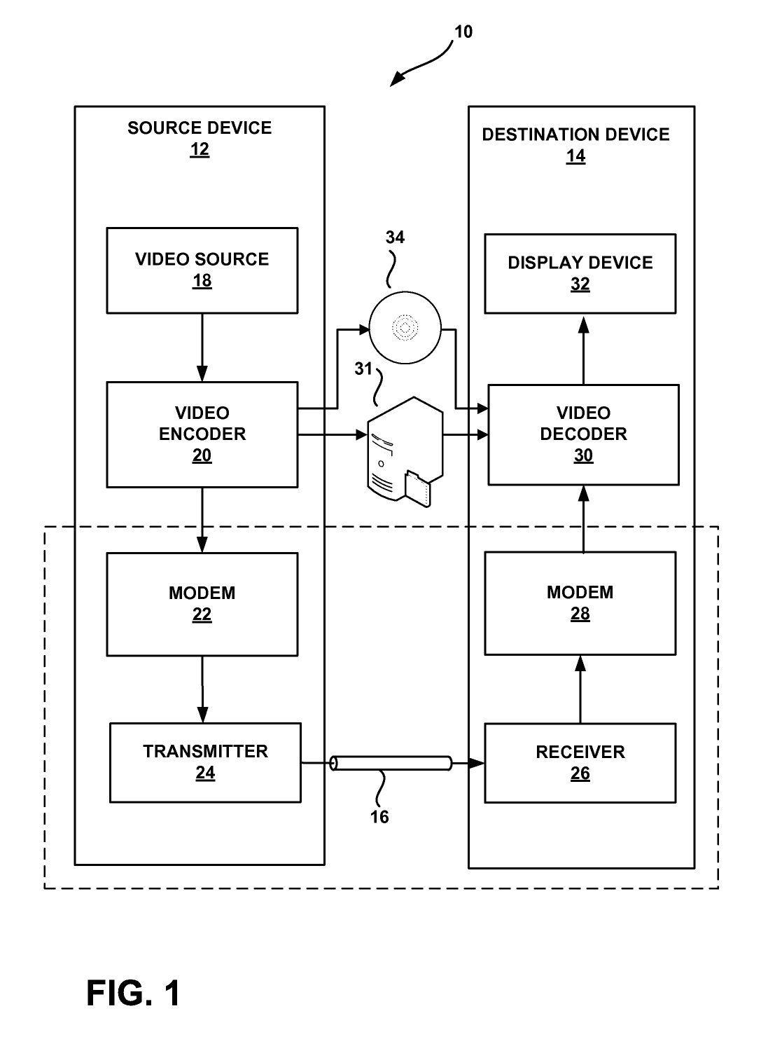

FIG. 1 is a block diagram illustrating an example video encoding and decoding system 10 that may utilize the video encoding techniques described in this disclosure. As shown in FIG. 1, system 10 includes a source device 12 that generates encoded video data to be decoded at a later time by a destination device 14. Source device 12 and destination device 14 may comprise any of a wide range of devices, including desktop computers, notebook (i.e., laptop) computers, tablet computers, set-top boxes, telephone handsets such as so-called “smart” phones, so-called “smart” pads, televisions, cameras, display devices, digital media players, video gaming consoles, or the like. In some cases, source device 12 and destination device 14 may be equipped for wireless communication. In some examples a source device 12 and a destination device 14 may be present in the same device, e.g., a wireless communication handset.

Destination device 14 may receive the encoded video data to be decoded via a link 16. Link 16 may comprise any type of medium or device capable of moving the encoded video data from source device 12 to destination device 14. In one example, link 16 may comprise a communication medium to enable source device 12 to transmit encoded video data directly to destination device 14 in real-time. The encoded video data may be modulated according to a communication standard, such as a wireless communication protocol, and transmitted to destination device 14. The communication medium may comprise any wireless or wired communication medium, such as a radio frequency (RF) spectrum or one or more physical transmission lines. The communication medium may form part of a packet-based network, such as a local area network, a wide-area network, or a global network such as the Internet. The communication medium may include routers, switches, base stations, or any other equipment that may be useful to facilitate communication from source device 12 to destination device 14.

In another example, encoded video may also be stored on a storage medium 34 or a file server 31 and may be accessed by the destination device 14 as desired. The storage medium may include any of a variety of locally accessed data storage media such as Blu-ray discs, DVDs, CD-ROMs, flash memory, or any other suitable digital storage media for storing encoded video data. Storage medium 34 or file server 31 may be any other intermediate storage device that may hold the encoded video generated by source device 12, and that destination device 14 may access as desired via streaming or download. The file server may be any type of server capable of storing encoded video data and transmitting that encoded video data to the destination device 14. Example file servers include a web server (e.g., for a website), an FTP server, network attached storage (NAS) devices, or a local disk drive. Destination device 14 may access the encoded video data through any standard data connection, including an Internet connection. This may include a wireless channel (e.g., a Wi-Fi connection), a wired connection (e.g., DSL, cable modem, etc.), or a combination of both that is suitable for accessing encoded video data stored on a file server. The transmission of encoded video data from the file server may be a streaming transmission, a download transmission, or a combination of both.

The techniques of this disclosure for video encoding are not necessarily limited to wireless applications or settings. The techniques may be applied to video coding in support of any of a variety of multimedia applications, such as over-the-air television broadcasts, cable television transmissions, satellite television transmissions, streaming video transmissions, e.g., via the Internet, encoding of digital video for storage on a data storage medium, decoding of digital video stored on a data storage medium, or other applications. In some examples, system 10 may be configured to support one-way or two-way video transmission to support applications such as video streaming, video playback, video broadcasting, and/or video telephony.

In the example of FIG. 1, source device 12 includes a video source 18, video encoder 20 and an output interface 22. In some cases, output interface 22 may include a modulator/demodulator (modem) and/or a transmitter. In source device 12, video source 18 may include a source such as a video capture device, e.g., a video camera, a video archive containing previously captured video, a video feed interface to receive video from a video content provider, and/or a computer graphics system for generating computer graphics data as the source video, or a combination of such sources. As one example, if video source 18 is a video camera, source device 12 and destination device 14 may form so-called camera phones or video phones. However, the techniques described in this disclosure may be applicable to video coding in general, and may be applied to wireless and/or wired applications.

The captured, pre-captured, or computer-generated video may be encoded by the video encoder 20. The encoded video information may be modulated by the modem 22 according to a communication standard, such as a wireless communication protocol, and transmitted to the destination device 14 via the transmitter 24. The modem 22 may include various mixers, filters, amplifiers or other components designed for signal modulation. The transmitter 24 may include circuits designed for transmitting data, including amplifiers, filters, and one or more antennas.

The destination device 14, in the example of FIG. 1, includes a receiver 26, a modem 28, a video decoder 30, and a display device 32. The receiver 26 of the destination device 14 receives information over the channel 16, and the modem 28 demodulates the information to produce a demodulated bitstream for the video decoder 30. The information communicated over the channel 16 may include a variety of syntax information generated by the video encoder 20 for use by the video decoder 30 in decoding video data. Such syntax may also be included with the encoded video data stored on a storage medium 34 or a file server 31. Each of the video encoder 20 and the video decoder 30 may form part of a respective encoder-decoder (CODEC) that is capable of encoding or decoding video data.

Display device 32 may be integrated with, or external to, destination device 14. In some examples, destination device 14 may include an integrated display device and also be configured to interface with an external display device. In other examples, destination device 14 may be a display device. In general, display device 32 displays the decoded video data to a user, and may comprise any of a variety of display devices such as a liquid crystal display (LCD), a plasma display, an organic light emitting diode (OLED) display, or another type of display device.

A video coder, as described in this disclosure, may refer to a video encoder or a video decoder. Similarly, a video encoder and a video decoder may be referred to as video encoding units and video decoding units, respectively. Likewise, video coding may refer to video encoding or video decoding.

Video encoder 20 and video decoder 30 may operate according to a video compression standard, such as the ITU-T H.264 standard, alternatively described as MPEG-4, Part 10, Advanced Video Coding (AVC). The techniques of this disclosure, however, are not limited to any particular coding standard. Although not shown in FIG. 1, in some aspects, video encoder 20 and video decoder 30 may each be integrated with an audio encoder and decoder, and may include appropriate MUX-DEMUX units, or other hardware and software, to handle encoding of both audio and video in a common data stream or separate data streams. If applicable, MUX-DEMUX units may conform to the ITU H.223 multiplexer protocol, or other protocols such as the user datagram protocol (UDP).

The ITU-T H.264/MPEG-4 (AVC) standard was formulated by the ITU-T Video Coding Experts Group (VCEG) together with the ISO/IEC Moving Picture Experts Group (MPEG) as the product of a collective partnership known as the Joint Video Team (JVT). In some aspects, the techniques described in this disclosure may be applied to devices that generally conform to the H.264 standard. The H.264 standard is described in ITU-T Recommendation H.264, Advanced Video Coding for generic audiovisual services, by the ITU-T Study Group, and dated March 2005, which may be referred to herein as the H.264 standard or H.264 specification, or the H.264/AVC standard or specification. The Joint Video Team (JVT) continues to work on extensions to H.264/MPEG-4 AVC.

Video encoder 20 and video decoder 30 each may be implemented as one or more microprocessors, digital signal processors (DSPs), application specific integrated circuits (ASICs), field programmable gate arrays (FPGAs), discrete logic, software, hardware, firmware or any combinations thereof. Each of video encoder 20 and video decoder 30 may be included in one or more encoders or decoders, either of which may be integrated as part of a combined encoder/decoder (CODEC) in a respective mobile device, subscriber device, broadcast device, server, or the like.

As will be described in more detail below, video encoder 20 may be configured to perform techniques for parallel video encoding in a multi-threaded processing system. In one example, video encoder 20 may be configured to determine an inter-prediction mode for a current macroblock of a frame of video data based on a motion vector predictor and a neighbor inter-prediction mode from one or more neighboring blocks, wherein the inter-prediction mode for the current macroblock is determined without considering a neighbor final prediction mode determined for the one or more neighboring blocks, determine an intra prediction mode for the current macroblock, determine a final prediction mode for the current macroblock from one of the determined inter prediction mode and the determined intra prediction mode, and perform a prediction process on the current macroblock using the final prediction mode. In one example, the step of determining the inter-prediction mode is performed for all macroblocks in the frame of video data in a first processing stage, and the step of determining the intra prediction mode is performed for all macroblocks in the frame of video data in a second processing stage, wherein the second processing stage occurs after the first processing stage.

While not limited to any particular video encoding standard, the techniques of this disclosure will be described with reference to the H.264 standard. In H.264, a video sequence typically includes a series of video frames. Video encoder 20 operates on video blocks within individual video frames in order to encode the video data. The video blocks may have fixed or varying sizes, and may differ in size according to a specified coding standard. Each video frame includes a series of slices. Each slice may include a series of macroblocks, which may be arranged into sub-blocks. As an example, the ITU-T H.264 standard supports intra prediction in various block sizes, such as 16 by 16, 8 by 8, or 4 by 4 for luma components, and 8×8 for chroma components, as well as inter prediction in various block sizes, such as 16 by 16, 16 by 8, 8 by 16, 8 by 8, 8 by 4, 4 by 8 and 4 by 4 for luma components and corresponding scaled sizes for chroma components. Video blocks may comprise blocks of pixel data, or blocks of transformation coefficients, e.g., following a transformation process such as discrete cosine transform (DCT) or a conceptually similar transformation process.

Smaller video blocks can provide better resolution, and may be used for locations of a video unit that include higher levels of detail. In general, macroblocks and the various sub-blocks may be considered to be video blocks. In addition, a slice or frame may be considered a video unit comprising a series of video blocks, such as macroblocks and/or sub-blocks. Each frame may be an independently decodable unit of a video sequence, and each slice may be an independently decodable unit of a video frame. The term “coded unit” refers to any independently decodable unit such as an entire frame, a slice of a frame, or another independently decodable unit defined according to applicable coding techniques.

Following predictive coding, and following any transforms, such as the 4×4 or 8×8 integer transform used in H.264/AVC or a discrete cosine transform (DCT), quantization may be performed. Quantization generally refers to a process in which coefficients are quantized to reduce the amount of data used to represent the coefficients. The quantization process may reduce the bit depth associated with some or all of the coefficients. For example, a 16-bit value may be rounded down to a 15-bit value during quantization. Following quantization, entropy coding may be performed, e.g., according to content adaptive variable length coding (CAVLC), context adaptive binary arithmetic coding (CABAC), or another entropy coding process.

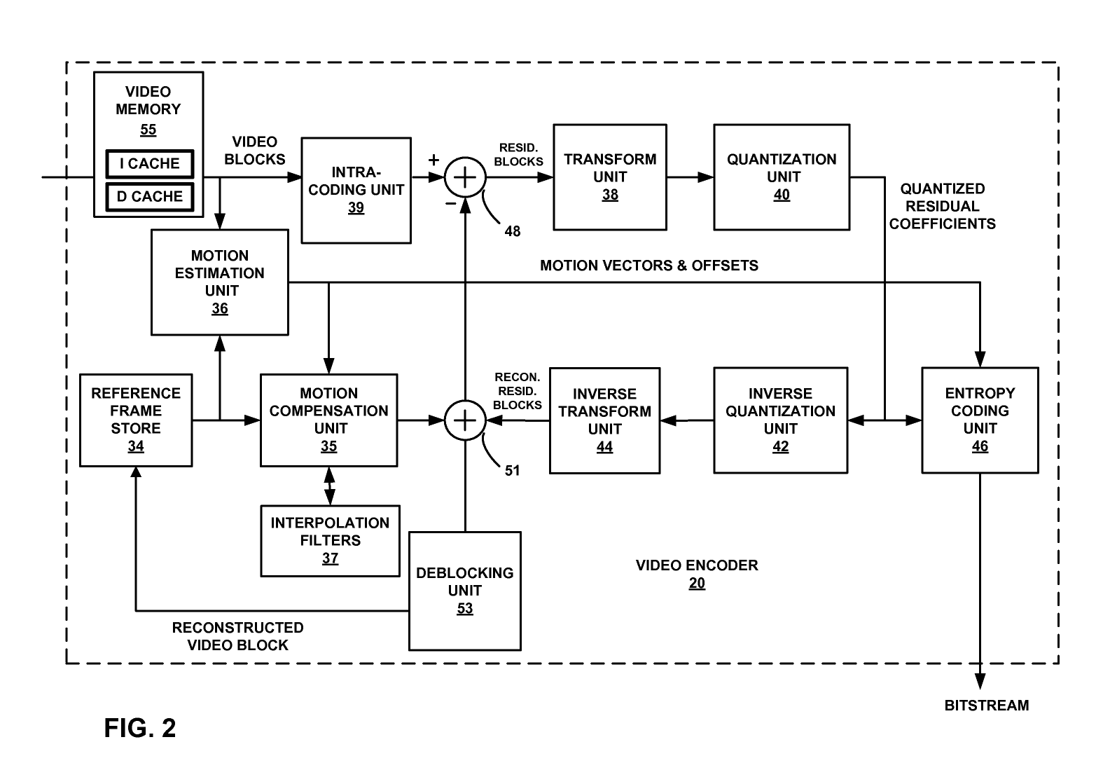

FIG. 2 is a block diagram illustrating an example of a video encoder 20 that may implement the techniques as described in this disclosure. Video encoder 20 may perform intra- and inter-coding of blocks within video units, such as frames or slices. Intra-coding relies on spatial prediction to reduce or remove spatial redundancy in video within a given video unit. Inter-coding relies on temporal prediction to reduce or remove temporal redundancy in video within adjacent units, such as frames, of a video sequence. Intra-mode (I-mode) may refer to the spatial based compression mode and inter-modes such as prediction (P-mode) or bi-directional (B-mode) may refer to the temporal-based compression modes.

As shown in FIG. 2, video encoder 20 receives a current video block within a video frame to be encoded. In the example of FIG. 2, video encoder 20 includes video memory 55, motion estimation unit 36, motion compensation unit 35, intra-coding unit 39, reference frame store 34, adder 48, transform unit 38, quantization unit 40, and entropy coding unit 46. For video block reconstruction, video encoder 20 also includes inverse quantization unit 42, inverse transform unit 44, and adder 51. A deblocking unit 53 may also be included to apply a deblocking filter to filter block boundaries to remove blockiness artifacts from reconstructed video. If desired, the deblocking filter may filter the output of adder 51.

Video memory 55 may store video data to be encoded by the components of video encoder 20 as well as instructions for units of video encoder 20 that may be implemented in a programmable processor (e.g., a digital signal processor). To that end, video memory 55 may include a data cache (D cache) to store video data, and an instruction cache (I cache) to store instructions. The video data stored in video memory 55 may be obtained, for example, from video source 18. Reference frame store 34 is one example of a decoded picture buffer (DPB) that stores reference video data for use in encoding video data by video encoder 20 (e.g., in intra- or inter-coding modes, also referred to as intra- or inter-prediction coding modes). Video memory 55 and reference frame store 34 may be formed by any of a variety of memory devices, such as dynamic random access memory (DRAM), including synchronous DRAM (SDRAM), magnetoresistive RAM (MRAM), resistive RAM (RRAM), or other types of memory devices. Video memory 55 and reference frame store 34 may be provided by the same memory device or separate memory devices. In various examples, video memory 55 may be on-chip with other components of video encoder 20, or off-chip relative to those components.

During the encoding process, video encoder 20 receives a video block to be coded, and motion estimation unit 36 and motion compensation unit 35 perform inter-predictive coding. Motion estimation unit 36 and motion compensation unit 35 may be highly integrated, but are illustrated separately for conceptual purposes. Motion estimation is typically considered the process of generating motion vectors, which estimate motion for video blocks, and result in identification of corresponding predictive blocks in a reference unit. A motion vector, for example, may indicate the displacement of a predictive block within a predictive frame (or other coded unit) relative to the current block being coded within the current frame (or other coded unit). Motion compensation is typically considered the process of fetching or generating the predictive block based on the motion vector determined by motion estimation. Again, motion estimation unit 36 and motion compensation unit 35 may be functionally integrated. For demonstrative purposes, motion compensation unit 35 is described as performing the selection of interpolation filters and the offset techniques of this disclosure.

Coding units in the form of frames will be described for purposes of illustration. However, other coding units such as slices may be used. Motion estimation unit 36 calculates a motion vector for the video block of an inter-coded frame by comparing the video blocks of a reference frame in reference frame store 34. Motion compensation unit 35 selects one of a plurality interpolation filters 37 to apply to calculate pixel values at each of a plurality of sub-pixel positions in a previously encoded frame, e.g., an I-frame or a P-frame. That is, video encoder 20 may select an interpolation filter for each sub-pixel position in a block.

Motion compensation unit 35 may select the interpolation filter from interpolation filters 37 based on an interpolation error history of one or more previously encoded frames. In particular, after a frame has been encoded by transform unit 38 and quantization unit 40, inverse quantization unit 42 and inverse transform unit 44 decode the previously encoded frame. In one example, motion compensation unit 35 applies the selected interpolation filters 37 to the previously encoded frame to calculate values for the sub-integer pixels of the frame, forming a reference frame that is stored in reference frame store 34.

Motion estimation unit 36 compares blocks of a reference frame from reference frame store 34 to a block to be encoded of a current frame, e.g., a P-frame or a B-frame. Because the reference frames in reference frame store 34 include interpolated values for sub-integer pixels, a motion vector calculated by motion estimation unit 36 may refer to a sub-integer pixel location. Motion estimation unit 36 sends the calculated motion vector to entropy coding unit 46 and motion compensation unit 35.

Motion compensation unit 35 may also add offset values, such as DC offsets, to the interpolated predictive data, i.e., sub-integer pixel values of a reference frame in reference frame store 34. Motion compensation unit 35 may assign the DC offsets based on the DC difference between a reference frame and a current frame or between a block of the reference frame and a block of the current frame. Motion compensation unit 35 may assign DC offsets “a priori,” i.e., before a motion search is performed for the current frame to be encoded, consistent with the ability to perform coding in a single pass.

With further reference to FIG. 2, motion compensation unit 35 calculates prediction data based on the predictive block. Video encoder 20 forms a residual video block by subtracting the prediction data from the original video block being coded to generate pixel difference values. Adder 48 represents the component or components that perform this subtraction operation. Transform unit 38 applies a transform, such as a discrete cosine transform (DCT) or a conceptually similar transform, to the pixel difference values in the residual block, producing a video block comprising residual transform block coefficients.

Transform unit 38, for example, may perform other transforms, such as those defined by the H.264 standard, which are conceptually similar to DCT. Wavelet transforms, integer transforms, sub-band transforms or other types of transforms could also be used. In any case, transform unit 38 applies the transform to the residual block, producing a block of residual transform coefficients. The transform may convert the residual information from a pixel domain to a frequency domain.

Quantization unit 40 quantizes the residual transform coefficients to further reduce bit rate. The quantization process may reduce the bit depth associated with some or all of the coefficients. For example, a 16-bit value may be rounded down to a 15-bit value during quantization. Following quantization, entropy coding unit 46 entropy codes the quantized transform coefficients. For example, entropy coding unit 46 may perform content adaptive variable length coding (CAVLC), context adaptive binary arithmetic coding (CABAC), or another entropy coding methodology. Following the entropy coding by entropy coding unit 46, the encoded video may be transmitted to another device or archived for later transmission or retrieval. The coded bitstream may include entropy coded residual blocks, motion vectors for such blocks, identifiers of interpolation filters to apply to a reference frame to calculate sub-integer pixel values for a particular frame, and other syntax including the offset values that identify the plurality of different offsets at different integer and sub-integer pixel locations within the coded unit.

Inverse quantization unit 42 and inverse transform unit 44 apply inverse quantization and inverse transformation, respectively, to reconstruct the residual block in the pixel domain, e.g., for later use as a reference block. Motion compensation unit 35 may calculate a reference block by adding the residual block to a predictive block of one of the frames of reference frame store 34. Motion compensation unit 35 may also apply the selected interpolation filters 37 to the reconstructed residual block to calculate sub-integer pixel values. Adder 51 adds the reconstructed residual block to the motion compensated prediction block produced by motion compensation unit 35 to produce a reconstructed video block for storage in reference frame store 34. The reconstructed video block may be used by motion estimation unit 36 and motion compensation unit 35 as a reference block to inter-code a block in a subsequent video frame.

As discussed above, the H.264 encoding process generally includes the processes of motion estimation and compensation (e.g., performed by motion estimation unit 36 and motion compensation unit 35), intra-mode estimation and prediction (e.g., performed by intra-coding unit 39), integer-based transforms (e.g., performed by transform unit 38), quantization and entropy encoding (e.g., performed by quantization unit 40 and entropy coding unit 46), deblocking (e.g., performed by deblocking unit 53), and sub-pel generation (e.g., performed by interpolation filters 37). There are several multi-threaded implementations (i.e., encoding in two or more parallel paths on different threads of a multi-threaded processor) to perform the foregoing encoding techniques that have been proposed for use in H.264-compliant encoders.

One example of a multi-threaded implementation of an H.264 encoder employs slice-level parallelism. In this example, a single frame is divided into multiple sub-frames (e.g., slices), and each sub-frame is operated on by multiple threads. This technique exhibits some drawbacks, since H.264 video data is encoded at the slice level. The encoding bit-rate increases with the addition of slices, and an H.264-compliant frame will have compulsory slices.

Another example of a multi-threaded implementation of an H.264 encoder employs frame-level parallelism. In this example, parallelism is exploited by using a combination of P-frames and B-frames. Parallel encoding in this example depends on how quickly P-frames are encoded. P-frames typically require a video encoder to perform computationally intensive motion estimation searches, which makes this technique less effective in some situations, as P-frames and B-frames may take a different time to encode.

In other examples, a combination of slice-level parallelism and frame-level parallelism is used. Such a combination may not be cache efficient (in terms of both data and instructions) since multiple threads would be working on different frames and different functional modules of the video encoder would be called.

Using a batch-server based method for parallel coding, which is a waterfall model, is described in U.S. Pat. No. 8,019,002, entitled Parallel batch decoding of video blocks, and assigned to Qualcomm Incorporated. This method works on multiple macroblocks the same frame, but on different groups of macroblocks using different functional modules of an H.264 encoder. This method is very efficient in terms of thread balancing. However, the instruction cache performance may not be optimal, since different groups of macroblocks are operated on by different functional modules of an H.264 encoder.

The batch-server model techniques of U.S. Pat. No. 8,019,002 utilize parallel processing technology in order to accelerate the encoding and decoding processes of image frames. The techniques may be used in devices that have multiple processors, or in devices that utilize a single processor that supports multiple parallel threads (e.g., a digital signal processor (DSP)). The techniques include defining batches of video blocks to be encoded (e.g., a group of macroblocks). One or more of the defined batches can be encoded in parallel with one another. In particular, each batch of video blocks is delivered to one of the processors or one of the threads of a multi-threaded processor. Each batch of video blocks is encoded serially by the respective processor or thread. However, the encoding of two or more batches may be performed in parallel with the encoding of other batches. In this manner, encoding of an image frame can be accelerated insofar as different video blocks of an image frame are encoded in parallel with other video blocks.

In one example, batch-server model parallel video encoding comprises defining a first batch of video blocks of an image frame, encoding the first batch of video blocks in a serial manner, defining a second batch of video blocks and a third batch of video blocks relative to the first batch of video blocks, and encoding the second and third batches of video blocks in parallel with one another.

In view of the foregoing drawbacks in video encoding implementations, including parallel video encoding implementations, this disclosure proposes techniques for video encoding that improve cache efficiency and provide a highly balanced multi-threaded implementation of a video encoder (e.g., an H.264 compliant video encoder) on a multi-threaded processor (e.g., a DSP).

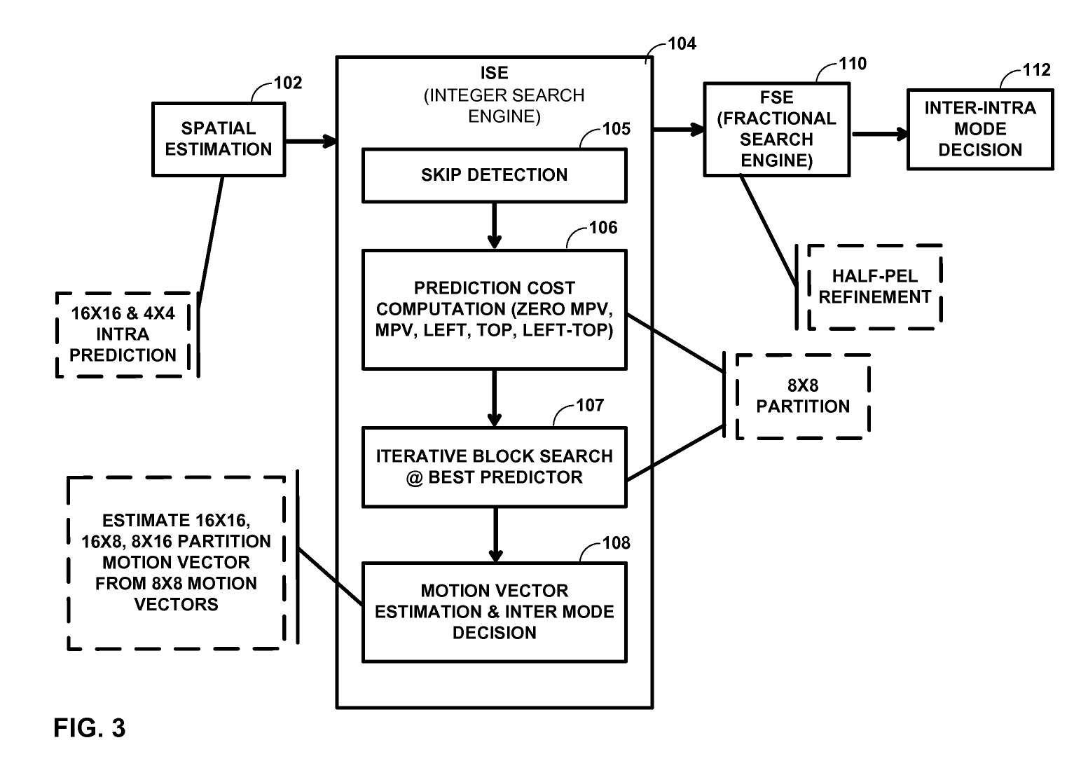

FIG. 3 is a conceptual diagram showing one example of a motion estimation and mode decision algorithm used in H.264 implementations. The algorithm depicted in FIG. 3 may be performed on a multi-threaded processor, such as a DSP. The task split of the different functional modules of an example H.264 encoder threads are as follows:

Inter-mode estimation: 220 MCPS (millions of cycles per second)

Intra-mode estimation, transformation estimation, transform processing, quantization, boundary strength (BS) calculation, variable length coding (VLC) encoding: 250 MCPS

Deblocking filtering & sub-pel generation (e.g., interpolation filtering): 60 MCPS.

First, spatial estimation unit 102 performs spatial estimation on the current macroblock (MB). In spatial estimation, a rate-distortion optimization (RDO) process (e.g., using the sum of absolute differences (SAD)) is performed for all possible intra-prediction modes, and then the mode corresponding to the lowest SAD value is chosen as the best intra mode.

For H.264, spatial estimation unit 102 may perform intra prediction on 16×16 and 4×4 blocks. For intra mode (spatial estimation), the entire encoding and reconstruction module (except deblocking) is completed in the same thread. This is done so that reconstructed pixels of neighboring blocks may be available as predictors for the intra-prediction of other blocks. As a result, intra-prediction and inter-prediction cannot be separated into two different threads.

Integer search engine 104 (ISE) performs inter-prediction. Initially, skip detection unit 105 determines if skip mode is to be used. In skip mode, neither a prediction residual nor a motion vector is signaled. Next, prediction cost computation unit 106 computes a rate-distortion cost (e.g., using the RDO process described above) for performing inter prediction with each of a zero motion vector predictor (MVP), MVP of a left neighboring block, MVP of a top neighboring block and MVP of a left-top neighboring block.

It should be understood that a “best” prediction mode (e.g., best intra mode or best inter mode) simply refers the mode that is determined in the spatial estimation process or inter-prediction process. Typically, a prediction mode (e.g., intra mode or inter mode) is chosen that gives the best results for a particular RDO process. This does not mean that a particular “best” prediction mode is optimal for all scenarios, but rather, that the particular prediction mode was selected given the specific techniques used in an RDO process. Some RDO processes may be designed to give more preference toward a better rate (i.e., more compression), while other RDO processes may be designed to give more preference toward less distortion (i.e., better visual quality). It should also be understood that the use SAD values for an RDO process is just one example. According to various aspects set forth in this disclosure, alternative methods for determining a best inter mode or best intra mode may be used. For example, in spatial estimation, a sum of squared differences (SSD) for all possible intra-prediction modes may be determined, and then the mode corresponding to the lowest SSD value may be chosen as the best intra mode. Alternatively, SAD or SSD methodologies may be selected based upon a metric, such as block size. Alternatively, other metrics or factors may be used alone or in conjunction with SAD or SSD to arrive at a best prediction mode.

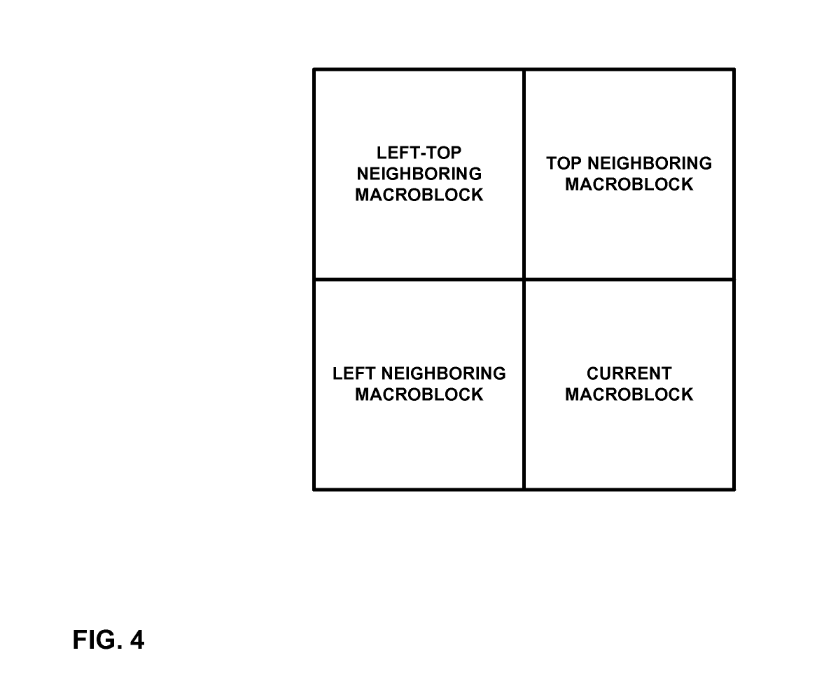

FIG. 4 is a conceptual diagram showing neighboring macroblocks from which MVPs and final prediction mode may be used for inter prediction. The cost computation may be performed for each 8×8 partition of a macroblock. Next, iterative block search unit 107 performs a search for a matching block using the best MVP determined by prediction cost computation unit 106. Again, the iterative block search may be performed for each 8×8 partition of a macroblock.

Next, motion vector estimation and inter mode decision unit 108 determines the motion vector and inter prediction mode for the macroblock. This may include estimate motion vectors for 16×16, 16×8 and 8×16 partitions of a macroblock from motion vectors determined for an 8×8 partition of the macroblock. Fractional search engine (FSE) 110 applies interpolation filters to the MVP to determine if additional compression may be achieved by shifting the predictive block by half-pel and/or quarter-pel values (i.e., half-pel refinement). Finally, based on a rate-distortion cost of using the intra mode determined by spatial estimation unit 102, and the best inter mode determined by ISE 104, inter-intra mode decision unit 112 determines the final prediction mode for the macroblock. That is, the prediction mode (either inter or intra) that provides the best rate-distortion cost, is chosen as the final prediction mode.

As discussed above, ISE 104 uses the MVP and the final mode (i.e., inter mode or intra mode) determined for neighboring macroblocks (MBs) to determine the inter mode for the current MB. For example, to determine the best inter mode of the current MB, the MVP for the current MB and the final prediction mode of each of the neighboring MB's are needed. If the final mode for the neighboring MBs is an intra mode, then the MVPs are not used for the current MB.

In contrast, the techniques of this disclosure do not use the final mode of the neighboring MBs (e.g., inter or intra) to determine the inter prediction mode of the current MB. Rather, this disclosure proposes using the best inter mode and best MVP determined for the neighboring block (neighbor inter mode and neighbor MVP), regardless of whether an intra mode is finally chosen for any particular neighboring MB. In this way, inter prediction processing may be performed for all MBs of a frame separately from any intra prediction processing because the final prediction mode (i.e., intra or inter) is not needed to determine the inter prediction mode of the current MB. This allows for more efficient parallel processing using a multi-threaded processor, such as a DSP.

Accordingly, in a first aspect of the disclosure, instead of using the final prediction mode of neighboring MBs to determine an inter prediction mode for the current MB, the best inter mode of the neighboring MBs is used to determine the best inter mode for the current MB. In this way, inter mode estimation and spatial estimation may be performed in two different threads. Hence, efficient multi-threading is possible so that all the threads can be balanced. From experimental results, the peak signal-to-noise ratio (PSNR) between the implementations using the final mode and best inter mode is slightly decreased without affecting visual quality. With a negligible drop in PSNR, the major advantage of using the best inter mode is the ability to employ a cache efficient multi-threading scheme.

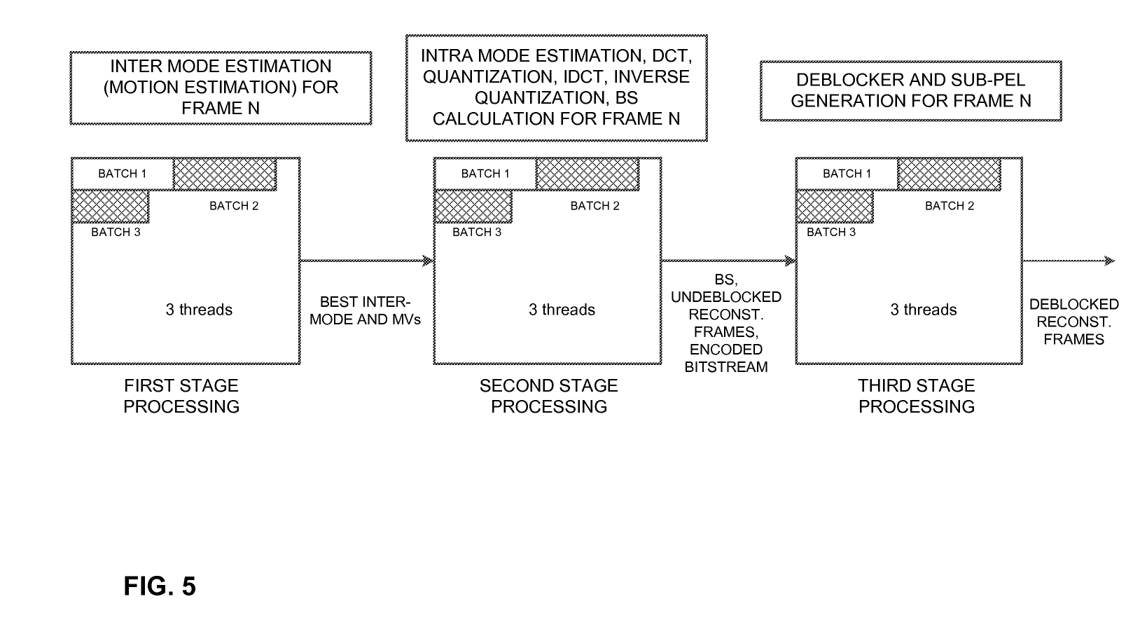

Given this change in the way inter prediction modes are determined, in a second aspect of the disclosure, a cache efficient multi-threaded design of video encoder (e.g., an H.264 video encoder) is proposed. FIG. 5 is a conceptual diagram showing a multi-threaded implementation of an H.264 encoder. Using the techniques of the first aspect of the disclosure, inter mode determination and prediction may be separated from intra mode determination.

As shown in FIG. 5, initially, inter-mode estimation is performed (e.g., by motion estimation unit 36 of FIG. 2) for the entire frame in a waterfall or batch-server model of parallel processing (e.g., as described in U.S. Pat. No. 8,019,002) with three software threads (e.g., executing on three DSP threads) in a first stage of processing. That is, inter mode estimation is performed serially on batch 1 MBs. After, batch 1 is completed, inter mode estimation may be performed in parallel on batch 2 and batch 3 MBs using two other software threads. After batch 2 and batch 3 MBs are completed, inter mode estimation may be performed on additional batches of MBs in frame N, three batches at a time (since there are three software threads). Note that more or fewer (e.g., 2) software threads may be used. In general, a batch server model of parallel processing may comprise n software threads that use k digital signal processor threads, wherein n is greater than or equal to k.

Since only functional modules of motion estimation (ME) run for each batch of MBs, most of the instructions would always be in the instruction cache (I cache) of video memory 55, as the same operations are being performed on the different batches of MBs. Also, since the group of MBs are processed in a waterfall (batch-server) model, the neighboring MB data is available and present in the data cache (D cache) of video memory 55. The results of the ME, i.e., the best inter mode and motion vectors (MVs) for the entire frame are put into the D cache and are made available to a second stage of processing.

In the second stage of processing, the following tasks are performed:

Spatial estimation is performed to decide the best intra mode (e.g., by intra-coding unit 39 of FIG. 2)

A final decision for the mode of the MB is made (i.e., intra or inter mode)

The MB is predicted based on the final mode to create a residual (e.g., by motion compensation unit 35 or intra-coding unit 39 of FIG. 2)

A discrete cosine transform (DCT) is applied to the residual to create transform coefficients (e.g., by transform unit 38 of FIG. 2)

The transform coefficients are quantized (e.g., by quantization unit 40 of FIG. 2)

An inverse DCT (IDCT) and inverse quantization are performed in the reconstruction loop (e.g., by inverse quantization unit 42 and inverse transform unit 44 of FIG. 2)

VLC is performed (e.g., by entropy coding unit 46 of FIG. 2)

A boundary strength (BS) calculation is made

Each of these steps in the second stage or processing is again operated for the entire frame in the batch-server (waterfall) model with, e.g., three software threads occupying three DSP threads in the same manner as described above for the first stage of processing. The resultant encoded bitstream may be sent to another processor (e.g., an ARM processor) for further processing. The results of this stage, i.e., the BS for the entire frame and the undeblocked reconstructed frame, are now available to a third stage of the processing.

In the third stage, the BS is used to apply a deblocking filter to the undeblocked reconstructed frame (i.e., a reference frame). In addition, sub-pel generation of the reference frames is performed. Sub-pel generation utilizes filters (e.g., interpolation filters 37 of FIG. 2) to generate sub-pel versions of reference frames, which may be used for ME search for the next frame. The DB and sub-pel filter again work in batch-server (waterfall) model with, e.g., three software threads occupying three DSP threads. Combining the deblocking filter and sub-pel filters to work together at the MB level in a processing stage may be considered a third aspect of this disclosure.

In all the three stages of processing, as explained above, the D cache is efficiently utilized due to spatial usage of neighboring pixels. That is, since neighboring macroblocks in a batch are operated on in a single thread, it is becomes more likely that all pixel data needed would be available in the D cache, thus reducing the need for data transfers. Furthermore, the I cache is efficiently used since the same modules in each stage of processing is run on all batches of MBs in a frame.

A third aspect of the disclosure includes techniques for sub-pixel plane generation (e.g., half-pel refinement) for motion estimation. Typically, sub-pixel values are generated on the fly using interpolation filters during motion estimation to determine the best sub-pixel motion vector. However, in examples of this disclosure, sub-pixel planes (i.e., sub-pixel values for one or more interpolation filters) are generated at a frame level and stored in memory.

For example, as shown in FIG. 5, sub-pixels may be generated for all MBs of a reconstructed frame (i.e., each particular frame N) by applying interpolation filters in a third stage of processing. This improves the DSP/CPU performance for performing sub-pixel generation at the cost of increased memory (e.g., double data rate synchronous dynamic random-access memory (DDR SDRAM)) bandwidth requirement). That is, more DDR SDRAM may be needed to store the sub-pixel values for an entire frame to be used for motion estimation for subsequent frames. However, DSP/CPU performance will be increased because data fetches and computations to produce sub-pixel values during motion estimation will no longer need to be performed.

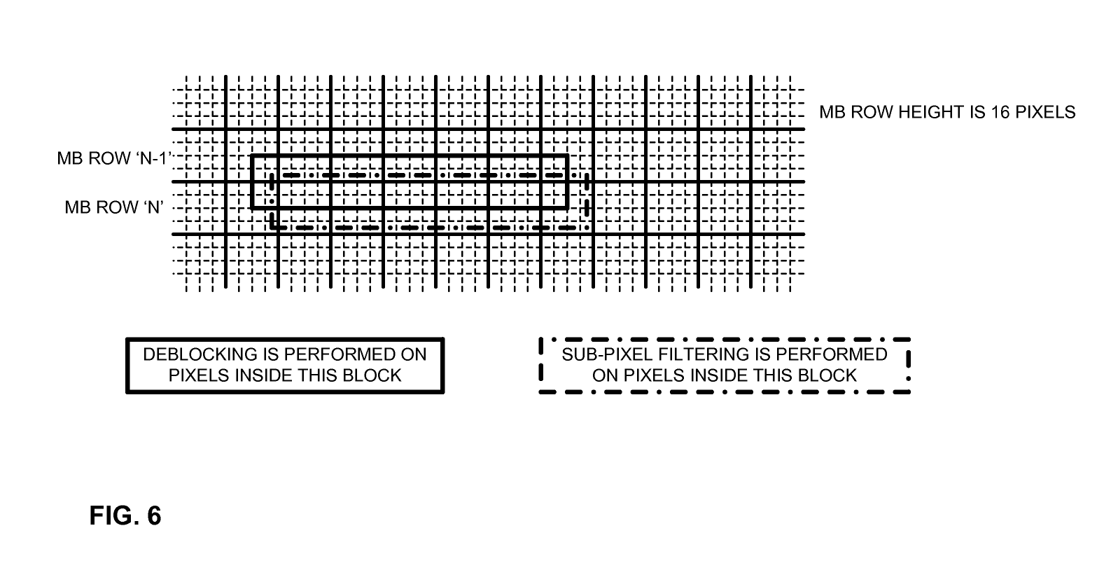

This sub-pixel frame generation may be combined with a deblocking filtering operation on a reconstructed frame. The result of the third stage of processing is a deblocked, reconstructed frame. This combination improves the cache performance for doing this operation. Since filtering for sub-pixel generation is performed on the post deblocked pixel values of the reconstructed frame, this operation may be performed in a staggered way, as shown in FIG. 6.

In example of FIG. 6, six filter taps are used by video encoder 20 (e.g., by motion compensation unit 35 using interpolation filters 37) to perform the sub-pixel filtering. More or fewer filter taps may be used. In FIG. 6, all six filter taps of the sub-pixel filter should fall on deblocked pixels for the filtering operation. This creates a staggering of at least three pixels both horizontally and vertically. The horizontal and vertical three pixel offset is shown by solid box (showing deblocking filtering) and the dashed box (showing sub-pixel filtering). That is, the sub-pixel frame output lags the deblocked pixels output by at least three pixels both horizontally and vertically. Deblocking and sub-pixel filtering are called alternately on a batch of MBs, and processing happens in the batch-server order for the entire frame.

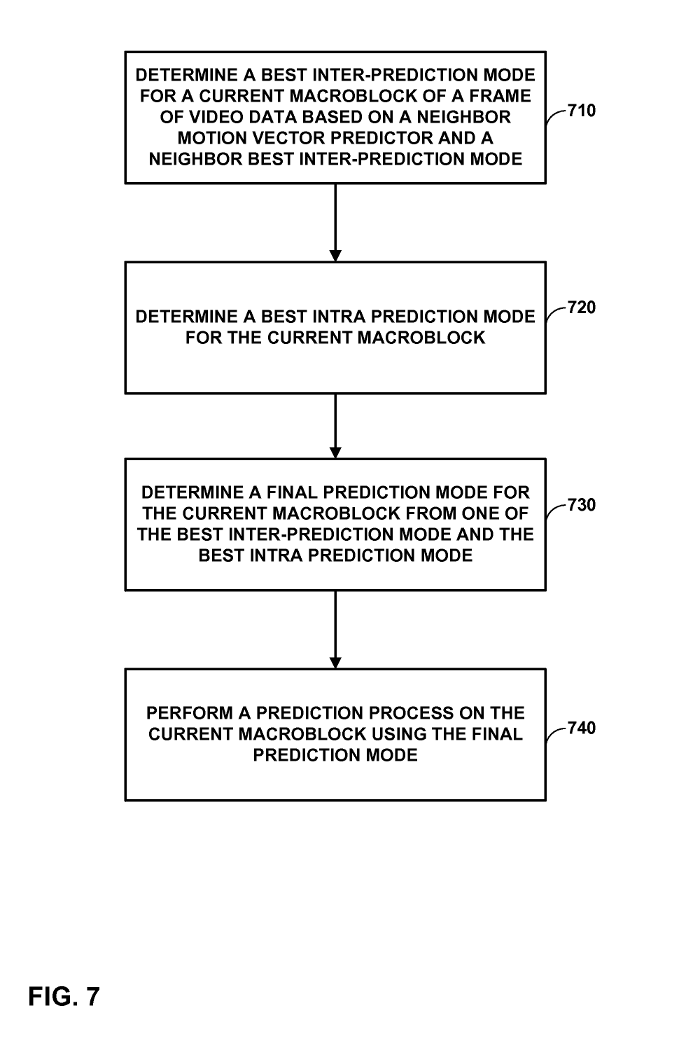

FIG. 7 is a flow diagram depicting an example method of the disclosure. The techniques of FIG. 7 may be carried out by one or more hardware units of video encoder 20.

In one example the disclosure, video encoder 20 may be configured determine an inter-prediction mode for a current macroblock of a frame of video data based on a neighbor motion vector predictor and a neighbor inter-prediction mode from one or more neighboring blocks (710) (e.g., the neighboring blocks shown in FIG. 4). Video encoder 20 may determine the inter-prediction mode for the current macroblock without considering a neighbor final prediction mode determined for the one or more neighboring blocks.

Video encoder 20 may be further configured to determining an intra prediction mode for the current macroblock (720), and determine a final prediction mode for the current macroblock from one of the determined inter-prediction mode and the determined intra prediction mode (730). Video encoder 20 may then perform a prediction process on the current macroblock using the final prediction mode.

In one example of the disclosure, the determined inter-prediction mode is a best inter-prediction mode identified by rate-distortion optimization process, and the determined intra prediction mode is a best intra prediction mode identified by the rate-distortion optimization process.

In another example of the disclosure, video encoder 20 may be configured to determine the inter-prediction mode for all macroblocks in the frame of video data in a first processing stage, and determine the intra prediction mode for all macroblocks in the frame of video data in a second processing stage, wherein the second processing stage occurs after the first processing stage.

In another example of the disclosure, video encoder 20 may be configured to determine the final prediction mode for all macroblocks in the frame of video data in the second processing stage, and perform the prediction process for all macroblocks in the frame of video data in the second processing stage.

In another example of the disclosure, video encoder 20 may be further configured to perform transformation and quantization, inverse transformation, inverse quantization, and boundary strength calculation for all macroblocks in the frame of video data in the second stage of processing.

In another example of the disclosure, video encoder 20 may be further configured to perform deblocking and sub-pel plane generation on reconstructed blocks of the frame of video data in a third stage of processing, wherein the third stage of processing occurs after the second stage of processing.

In another example of the disclosure, the first processing stage, the second processing stage, and the third processing stage use a batch-server mode of processing. In one example, the batch-server mode of processing for the first processing stage, the second processing stage, and the third processing stage uses n software threads. In one example, n is 3. In another example, the n software threads use k digital signal processor threads, wherein n is greater than or equal to k.

The techniques of this disclosure may be realized in a wide variety of devices or apparatuses, including a wireless handset, an integrated circuit (IC) or a set of ICs (i.e., a chip set). Any components, modules or units have been described provided to emphasize functional aspects and does not necessarily require realization by different hardware units.

The techniques described in this disclosure may be implemented, at least in part, in hardware, software, firmware or any combination thereof. For example, various aspects of the described techniques may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry.

Such hardware, software, and firmware may be implemented within the same device or within separate devices to support the various operations and functions described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware or software components. Rather, functionality associated with one or more modules or units may be performed by separate hardware or software components, or integrated within common or separate hardware or software components.

The techniques described herein may also be embodied or encoded in a computer-readable medium, such as a computer-readable storage medium, containing instructions. Instructions embedded or encoded in a computer-readable medium may cause a programmable processor, or other processor, to perform the method, e.g., when the instructions are executed. Computer readable storage media may include random access memory (RAM), read only memory (ROM), programmable read only memory (PROM), erasable programmable read only memory (EPROM), electronically erasable programmable read only memory (EEPROM), flash memory, a hard disk, a CD-ROM, a floppy disk, a cassette, magnetic media, optical media, or other computer readable media.

Various examples have been described. These and other examples are within the scope of the following claims.

What is claimed is:

1. A method of encoding video data, the method comprising:
determining an inter-prediction mode for a current macroblock of a frame of video data based on a neighbor motion vector predictor and a neighbor inter-prediction mode from one or more neighboring blocks, wherein the inter-prediction mode for the current macroblock is determined without considering a neighbor final prediction mode determined for the one or more neighboring blocks;
determining an intra prediction mode for the current macroblock;
determining a final prediction mode for the current macroblock from one of the determined inter-prediction mode and the determined intra prediction mode; and
performing a prediction process on the current macroblock using the final prediction mode.

2. The method of claim 1, wherein the determined inter-prediction mode is a best inter-prediction mode identified by rate-distortion optimization process, and wherein the determined intra prediction mode is a best intra prediction mode identified by the rate-distortion optimization process.

3. The method of claim 1, the determining the inter-prediction mode comprising determining the inter-prediction mode for all macroblocks in the frame of video data in a first processing stage, and
the determining the intra prediction mode comprising determining the intra prediction mode for all macroblocks in the frame of video data in a second processing stage, wherein the second processing stage occurs after the first processing stage.

4. The method of claim 3, the determining the final prediction mode comprising determining the final prediction mode for all macroblocks in the frame of video data in the second processing stage, and
the performing the prediction process comprising performing the prediction process for all macroblocks in the frame of video data in the second processing stage.

5. The method of claim 4, further comprising:
performing transformation and quantization, inverse transformation, inverse quantization, and boundary strength calculation for all macroblocks in the frame of video data in the second stage of processing.

6. The method of claim 5, further comprising:
performing deblocking and sub-pel plane generation on reconstructed blocks of the frame of video data in a third stage of processing, wherein the third stage of processing occurs after the second stage of processing.

7. The method of claim 6, wherein the first processing stage, the second processing stage, and the third processing stage use a batch-server mode of processing.

8. The method of claim 7, wherein the batch-server mode of processing for the first processing stage, the second processing stage, and the third processing stage uses n software threads.

9. The method of claim 8, wherein n is 3.

10. The method of claim 8, wherein the n software threads use k digital signal processor threads, wherein n is greater than or equal to k.

11. An apparatus configured to encode video data, the apparatus comprising:
a video memory configured to store video data; and
a video encoder operatively coupled to the video memory, the video encoder configured to:
determine an inter-prediction mode for a current macroblock of a frame of video data based on a neighbor motion vector predictor and a neighbor inter-prediction mode from one or more neighboring blocks, wherein the inter-prediction mode for the current macroblock is determined without considering a neighbor final prediction mode determined for the one or more neighboring blocks;
determine an intra prediction mode for the current macroblock;
determine a final prediction mode for the current macroblock from one of the determined inter-prediction mode and the determined intra prediction mode; and
perform a prediction process on the current macroblock using the final prediction mode.

12. The apparatus of claim 11, wherein the determined inter-prediction mode is a best inter-prediction mode identified by rate-distortion optimization process, and wherein the determined intra prediction mode is a best intra prediction mode identified by the rate-distortion optimization process.

13. The apparatus of claim 11, wherein the video encoder is further configured to determine the inter-prediction mode for all macroblocks in the frame of video data in a first processing stage, and
determine the intra prediction mode for all macroblocks in the frame of video data in a second processing stage, wherein the second processing stage occurs after the first processing stage.

14. The apparatus of claim 13, wherein the video encoder is further configured to determine the final prediction mode for all macroblocks in the frame of video data in the second processing stage, and
perform the prediction process for all macroblocks in the frame of video data in the second processing stage.

15. The apparatus of claim 14, wherein the video encoder is further configured to:
perform transformation and quantization, inverse transformation, inverse quantization, and boundary strength calculation for all macroblocks in the frame of video data in the second stage of processing.

16. The apparatus of claim 15, wherein the video encoder is further configured to:
perform deblocking and sub-pel plane generation on reconstructed blocks of the frame of video data in a third stage of processing, wherein the third stage of processing occurs after the second stage of processing.

17. The apparatus of claim 16, wherein the video encoder is further configured to perform the first processing stage, the second processing stage, and the third processing stage using a batch-server mode of processing.

18. The apparatus of claim 17, wherein the video encoder is further configured to use the batch-server mode of processing for the first processing stage, the second processing stage, and the third processing stage by using n software threads.

19. The apparatus of claim 18, wherein n is 3.

20. The apparatus of claim 18, wherein the n software threads use k digital signal processor threads, wherein n is greater than or equal to k.

21. An apparatus configured to encode video data, the apparatus comprising:
means for determining an inter-prediction mode for a current macroblock of a frame of video data based on a neighbor motion vector predictor and a neighbor inter-prediction mode from one or more neighboring blocks, wherein the inter-prediction mode for the current macroblock is determined without considering a neighbor final prediction mode determined for the one or more neighboring blocks;
means for determining an intra prediction mode for the current macroblock;
means for determining a final prediction mode for the current macroblock from one of the determined inter-prediction mode and the determined intra prediction mode; and
means for performing a prediction process on the current macroblock using the final prediction mode.

22. The apparatus of claim 21, the means for determining the inter-prediction mode comprising means for determining the inter-prediction mode for all macroblocks in the frame of video data in a first processing stage, and
the means for determining the intra prediction mode comprising means for determining the intra prediction mode for all macroblocks in the frame of video data in a second processing stage, wherein the second processing stage occurs after the first processing stage.

23. The apparatus of claim 22, the means for determining the final prediction mode comprising means for determining the final prediction mode for all macroblocks in the frame of video data in the second processing stage, and
the means for performing the prediction process comprising means for performing the prediction process for all macroblocks in the frame of video data in the second processing stage.

24. The apparatus of claim 23, further comprising:
means for performing deblocking and sub-pel plane generation on reconstructed blocks of the frame of video data in a third stage of processing, wherein the third stage of processing occurs after the second stage of processing.

25. The apparatus of claim 24, wherein the first processing stage, the second processing stage, and the third processing stage use a batch-server mode of processing.

26. A non-transitory computer-readable storage medium storing instructions that, when executed, cause one or more processors of a device configured to encode video data to:
determine an inter-prediction mode for a current macroblock of a frame of video data based on a neighbor motion vector predictor and a neighbor inter-prediction mode from one or more neighboring blocks, wherein the inter-prediction mode for the current macroblock is determined without considering a neighbor final prediction mode determined for the one or more neighboring blocks;
determine an intra prediction mode for the current macroblock;
determine a final prediction mode for the current macroblock from one of the determined inter-prediction mode and the determined intra prediction mode; and
perform a prediction process on the current macroblock using the final prediction mode.

27. The non-transitory computer-readable storage medium of claim 26, wherein the instructions further cause the one or more processors to determine the inter-prediction mode for all macroblocks in the frame of video data in a first processing stage, and
determine the intra prediction mode for all macroblocks in the frame of video data in a second processing stage, wherein the second processing stage occurs after the first processing stage.

28. The non-transitory computer-readable storage medium of claim 27, wherein the instructions further cause the one or more processors to determine the final prediction mode for all macroblocks in the frame of video data in the second processing stage, and
perform the prediction process for all macroblocks in the frame of video data in the second processing stage.

29. The non-transitory computer-readable storage medium of claim 28, wherein the instructions further cause the one or more processors to:
perform deblocking and sub-pel plane generation on reconstructed blocks of the frame of video data in a third stage of processing, wherein the third stage of processing occurs after the second stage of processing.

30. The non-transitory computer-readable storage medium of claim 29, wherein the instructions further cause the one or more processors to perform the first processing stage, the second processing stage, and the third processing stage using a batch-server mode of processing.
